(19) United States
(12) Patent Application Publication
(10) Pub. No.: US 2008/0004866 A1
(43) Pub. Date: Jan. 3, 2008

(54) Artificial Bandwidth Expansion Method For A Multichannel Signal

(75) Inventors: Jussi Virolainen, Espoo (FI); Laura Laaksonen, Espoo (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/427,856

(22) Filed: Jun. 30, 2006

(51) Int. Cl. G10L 19/14

(52) U.S. Cl. 704/205

(57) ABSTRACT

Techniques for applying artificial bandwidth expansion to a multichannel signal are described. Aspects of a system for applying artificial bandwidth expansion to a multichannel signal include an estimation component for receiving a multichannel signal and estimating delay and energy level differences for each channel of the multichannel signal. An artificial bandwidth expansion component artificially expands the bandwidth of each of the channels of the multichannel signal separately. Each one of a plurality of adjustment components are configured to modify a different one of the artificial bandwidth expanded channels of the multichannel signal based upon the estimated delay and energy level differences. The multichannel signal may be a binaural speech signal.

### BACKGROUND

During audio conferencing, multiple parties in different locations can discuss an issue or project without having to physically be in the same location. Audio conferencing allows for individuals to save both time and money from having to meet together in on place. Yet in comparison to video conferencing, audio conferencing has some drawbacks. One such drawback is that a video conference allows an individual to easily discern who is speaking at any given time. However, during an audio conference, it is sometimes difficult to recognize the identity of a speaker. The inferior speech quality of narrowband speech coders/decoders (codecs) contributes to this problem.

Spatial audio technology is one manner to improve quality of communication in conferencing systems. Spatialization or three dimensional (3D) processing means that voices of other conference attendees are located at different virtual positions around a listener. During a conference session, a listener can perceive, for example, that a certain attendee is on the left side, another attendee is in front, and third attendee is on the right side. Spatialization is typically done by exploiting three dimensional (3D) audio techniques, such as Head Related Transfer Function (HRTF) filtering to produce a binaural output signal to the listener. For such a technique, the listener needs to wear stereo headphones, have stereo loudspeakers, or a multichannel reproduction system such as a 5.1 speaker system to reproduce 3D audio. In certain instances, additional cross-talk cancellation processing is provided for loudspeaker reproduction.

Spatial audio is one manner to improve quality of communication in teleconferencing systems. Spatial audio improves speech intelligibility, makes speaker detection easier, makes speaker separation easier, prevents listening fatigue, and makes conference environment sound more natural and satisfactory.

The spatialization is done by exploiting 3D audio techniques, such as HRTF filtering. There, mono input signal is processed to produce spatialized signal that is typically a binaural signal, e.g., suitable for headphone reproduction, or other multichannel signal. The sound source is panned in a binaural signal by modifying both amplitude and delay. Reproduction of spatial audio requires stereo headphones, stereo loudspeakers, or a multiple loudspeaker system.

Traditionally, narrowband coding is used to transmit speech signals in both fixed and circuit-switched mobile networks. The limitations of using wideband speech have been the bandwidth of the transmission channel and standards that do not support wideband speech codecs. A GSM enhanced full-rate (EFR)/adaptive multi-rate narrowband (AMR-NB) codec is able to transmit a speech band of 300-3400 Hz. Better speech quality can be achieved by using wideband speech codecs that are able to preserve frequency content of the signal also for higher frequencies, 50-7000 Hz, as in an adaptive multi-rate wideband (AMR-WB) codec. Most speech calls are narrowband, because if some of the terminals or network elements between them do not support wideband, the whole call is transformed into narrowband. Furthermore, the lack of computational power might sometimes force the speech processing unit to operate in narrowband, since other speech enhancement algorithms are much more expensive in wideband mode.

“Binaural and Spatial Hearing in Real and Virtual Environments”: Editors: R. H. Gilkey and T. R. Anderson; Lawrence Erlbaum Associates; Mahwah, N.J.; 1997 shows that performance of a three-dimensional (3D) audio system depends highly on the signal bandwidth to be used. When spatialization is done at low sampling rates, fs=8 kHz, or correspondingly, if the signal itself to be spatialized is band limited, 4 kHz bandwidth, the performance of the conferencing system is limited. From the listener's perspective, it can be difficult to detect whether a narrowband sound source is spatialized to a front or a corresponding back position as both positions have a same interaural time difference value. Also, perception of elevation is difficult for narrowband signals. With wideband signals, 8 kHz bandwidth, front-back separation is easier, and it is even possible to spatialize sound sources for different levels of elevation. Another advantage is that the auditory system can localize a wideband signal more accurately than a narrowband signal. The concept of “localization blur” describes finite spatial resolution of the auditory system, such as described in Blauert, J.; “Spatial Hearing: The Psychophysics of Human Sound Localization”; Rev. Ed.; The MIT Press; 1996. A point source produces an auditory event that is spread, i.e., blurred, out in the space. In 3D teleconferencing, wideband speech sources that are positioned near each other can be segregated easier than narrowband speech sources due to smaller localization blur. Improved localization accuracy and the possibility to localize sources to more difficult positions means improved performance of 3D teleconferencing.

In conferencing applications, certain talkers can be silent for a long period of time before starting to talk. In such a situation, the exact positioning of more than a few spatial positions can be very difficult if not impossible. In addition, the ability of a listener to memorize accurately where a certain speaker is positioned decays as time passes. The human aural sense is sensitive for comparing two stimuli to each other, but insensitive for estimating absolute values, or comparing stimuli to a memorized reference.

A listener can detect reliably three spatial positions when speakers are located with one on the left, one on the right, and one in front. When more positions are used for additional speakers, the probability of confusion for a listener increases. FIG. 1 illustrates such a configuration. With respect to a listener 100, five category positions are far-left 102, left-front 104, front 106, right-front 108, and far-right 110. Listening experiments indicate that more errors are made between positions that have adjacent positions at both sides. For example, confusion occurs between positions that are at the same side, such as front-right 108 and far-right 110. In such an orientation, a far-right speaker is likely to be judged correctly to be far-right 110, but a front-right speaker can be confused to be the far-right speaker or even to a front position 106. In addition, the ability of a listener to localize sound sources to both front and back positions is relatively poor. Front-back confusion is quite a typical phenomenon in 3D audio systems.

In centralized 3D teleconferencing, the conference bridge takes care of spatialization and produces a binaural or other multichannel signal. This signal is encoded and transmitted to the terminal, which decodes the signal. If the signal was a monophonic signal, bandwidth extension could be applied, since artificial bandwidth expansion has been developed for monophonic speech signals. Erik Larsen, Ronald M. Aarts; “Audio Bandwidth Extension, Application of Psychoacoustics, Signal Processing and Loudspeaker Design”, Wiley Publishing; 2004 describes monophonic signal bandwidth expansion. However, the individual channels of a binaural, i.e., two channel signal, or other multichannel signal are not monophonic speech signals. Each of the channels can contain energy of one or more simultaneous speech sources and the phase difference between the channels is simple if there is only one speaker at a time. When there are simultaneous speakers, energy from each speech source can have a different interaural time difference (ITD) between the channels.

In the following example, binaural signal contains speech of two simultaneous speakers that are positioned to opposite sides. FIG. 2 illustrates this example. In this example, Talker A is positioned to the left side of a listener and the speech signal for Talker A reaches the listener's left ear first. The signal at the listener's right ear is a delayed and a filtered version of the signal first reaches the left ear. This filtered version is due to head shadow effect. For Talker B, the speech signal reaches the listener's right ear first and the signal at left ear is a delayed and filtered version.

One illustrative architecture for audio processing is a centralized teleconferencing system where a conference bridge is capable of transmitting stereo signal to terminals. FIG. 3 illustrates an example centralized stereo teleconferencing system. Example centralized teleconferencing system 300 includes a conference bridge 301 and a plurality of user terminals 351-357. From the audio system point of view, conference bridge 301 receives mono audio streams 371, such as microphone signals, from the terminals, such as terminal 351, and processes them, e.g., perform automatic gain control, active stream detection, mixing, spatialization, by a signal processing component 303 to provide a stereo output signal, such as lines 373 and 375, to the user terminals. The user terminals 351-357 capture audio and reproduce stereo audio.

The stereophonic sound can be transmitted as two separately coded mono channels, e.g., using two (2) adaptive multi-rate (AMR) codecs, or as one stereo coded channel, e.g., using an advanced audio encoding (AAC) codec. Currently there are no low latency stereo speech codecs available. As such, conventional speech codecs used in conferencing systems are narrowband codecs.

### SUMMARY

There exists a need for a system and method to artificially expand each channel of a multichannel signal for use in teleconferencing. Aspects of the invention are directed to a system for applying artificial bandwidth expansion to a narrowband multichannel signal, including an estimation component configured to receive a narrowband multichannel signal and to estimate delay and energy level differences for each channel of the narrowband multichannel signal. The estimated delay and energy level differences may be based upon a similarity metrics, such as average magnitude difference function (AMDF). An artificial bandwidth expansion component artificially expands the bandwidth of each of the channels of the narrowband multichannel signal separately. Then, each of a plurality of adjustment components modifies a different one of the artificial bandwidth expanded channels of the narrowband multichannel signal based upon the estimated delay and energy level differences.

Aspects of the invention provide a method of and means for estimating delay and energy level differences for each channel of a narrowband multichannel signal, performing artificial bandwidth expansion of each of the channels of the narrowband multichannel signal separately, and modifying the artificial bandwidth expanded channels of the narrowband multichannel signal based upon the estimated delay and energy level differences. The narrowband multichannel signal may be a binaural speech signal used during a conference call.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates an example configuration of five category positions that a listener can memorize and separate;

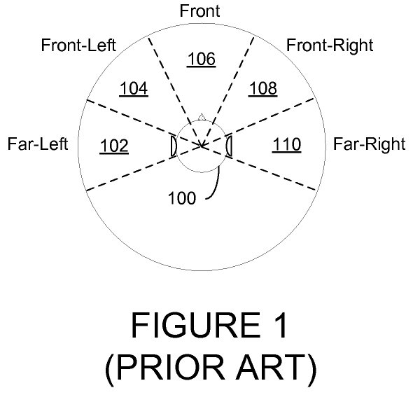

FIG. 2 illustrates an example of a binaural signal with two simultaneous speakers;

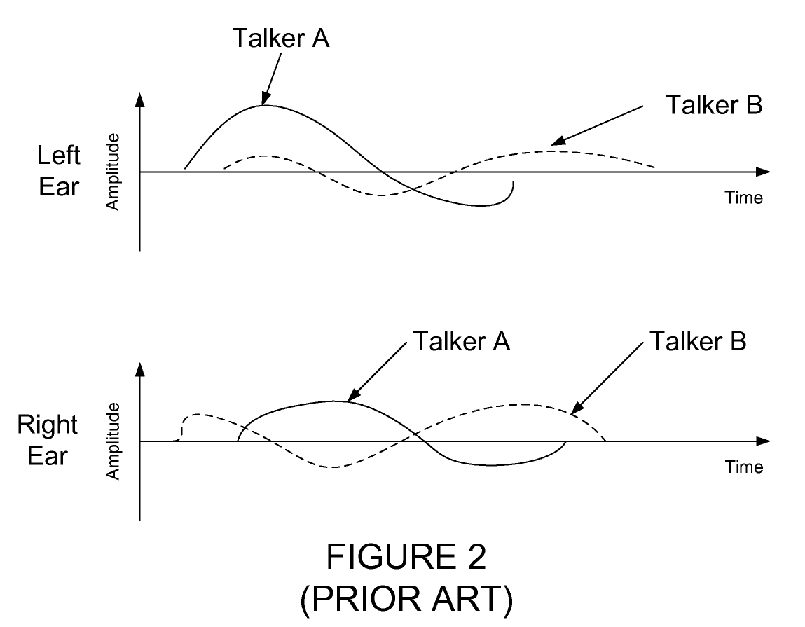

FIG. 3 is a block diagram of an illustrative centralized stereo teleconferencing system;

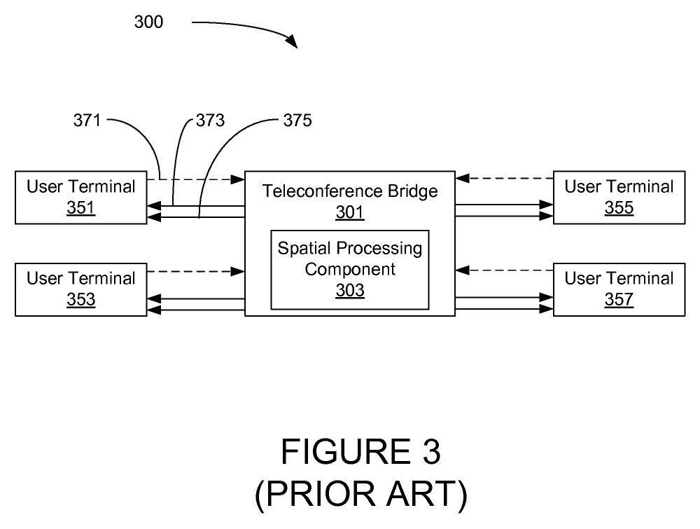

FIG. 4 illustrates an example block diagram of a system applying an artificial bandwidth expansion method for binaural speech signals (B-ABE) in accordance with aspects of the present invention; and

FIG. 5 is a flowchart of an illustrative example of a method for applying an artificial bandwidth expansion method for binaural speech signals (B-ABE) in accordance with at least one aspect of the present invention.

### DETAILED DESCRIPTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

Aspects of the present invention describe an artificial bandwidth expansion method for binaural speech signals (B-ABE). A binaural speech signal is a two-channel signal, left and right channels, which may contain speech of one talker or several simultaneous talkers. A binaural speech signal is produced from a monophonic speech signal, for example, by head related transfer function (HRTF) processing and mixing a plurality of these signals in a conference bridge of a centralized 3D audio conferencing system. Alternatively, a binaural signal is generated by making a recording with an artificial head, e.g., a mechanical model of a human head, and possibly torso, which has microphones in the ear canals. A KEMAR-mannequin, Knowles Electronics Mannequin for Acoustic Research mannequin, is one example of a commercial artificial head. In another embodiment, a user wears a binaural headset, which includes microphones mounted in the earpiece. The binaural signal is encoded and transmitted to the terminal. If narrowband coding is used, the receiving terminal may apply artificial bandwidth extension for speech intelligibility enhancement and 3D audio representation improvement.

Artificial bandwidth expansion algorithms typically double the sampling frequency of a signal from, e.g., 8 kHz to 16 kHz and add new spectral components to the high band, i.e., from 4 kHz to 8 kHz. This conversion from narrowband to wideband may be either totally artificial, so no extra information is transmitted or some side information concerning the missing frequency components may be transmitted. Compared to narrowband speech, artificial wideband speech has better quality and it is more intelligible. An artificial bandwidth expansion method for binaural signals (B-ABE) may be used within a system in which two separately coded channels are transmitted from a conference bridge to a user terminal. In addition, aspects of the present invention are directed other multichannel signals, such as three channels, applied to stereo speech codecs. Aspects of the present invention may also be utilized for bandwidth expansion towards low frequencies. New spectral components may be added to a low band, e.g., 100-300 Hz, signal if the bandwidth of an input signal is, e.g., 300-3400 Hz.

As described herein, aspects of the present invention apply ABE for binaural, i.e., stereo, speech signals, monaural signals, amplitude panned signals, delay panned signals, and dichotic speech signals. Aspects of the present invention improve quality and intelligibility of narrowband binaural speech, while implementation may be inexpensive from a computational point of view compared to true wideband binaural speech, because all the other speech enhancement algorithms may operate in narrowband mode before the expansion. In addition, aspects of the present invention work with all ABE algorithms designed for monophonic speech.

Specifically with respect to 3D teleconferencing, aspects of the present invention improve speech intelligibility due to a wider speech bandwidth. A wider speech bandwidth improves localization accuracy which makes it possible to use more spatial positions for sound sources, e.g., positions at listeners back or using elevation, which improves performance of the 3D teleconference system. When stereo hands-free speakers are used, only narrowband stereo echo cancellation algorithm is required; while wideband echo cancellation is required with wideband codecs. Aspects of the present invention may be implemented in a terminal device or in a gateway to connect wideband and narrowband terminal devices. 3D representation and room effect may attenuate some artefacts generated in the bandwidth extension processing.

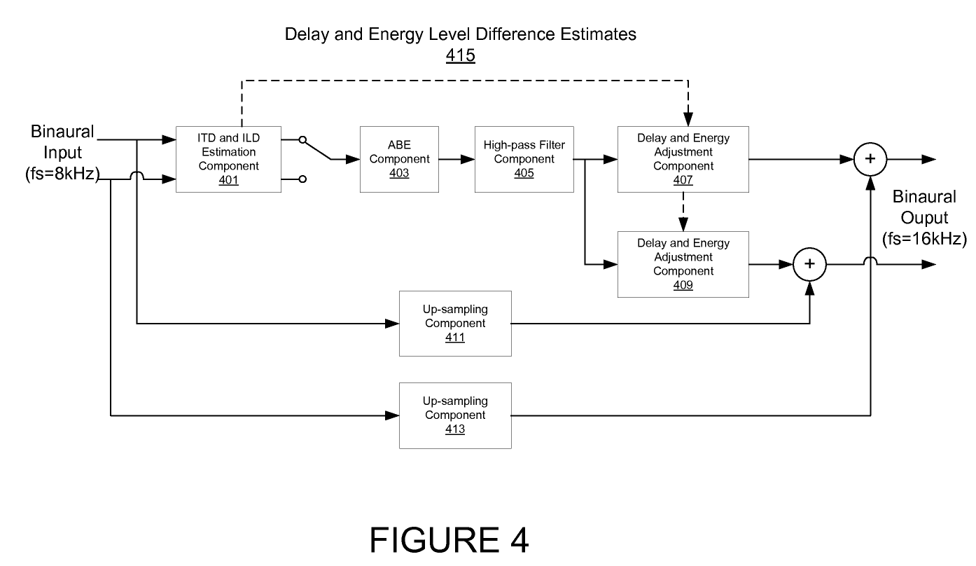

FIG. 4 illustrates an example block diagram of a system applying an artificial bandwidth expansion method for binaural speech signals (B-ABE) in accordance with aspects of the present invention. As shown, both channels, corresponding to a left and right perspective, of a narrowband binaural input signal with a low sampling rate, such as fs=8 kHz, is inputted to an interaural time difference (ITD) and interaural level difference (ILD) estimation component 401. The ITD and ILD estimation component 401 is configured to estimate the delay and energy level difference between the left and right channels from the narrowband binaural signal. ITD and ILD component 401 may be configured to initiate estimation based upon metadata in an input signal that indicates that the input signal is a binaural or other multichannel speech signal. As such, in accordance with aspects of present invention, the system may be configured to process different types of multichannel input signals and process accordingly based upon metadata received in the input signal.

For one channel, a conventional monophonic artificial bandwidth expansion (ABE) component 403 performs artificial expansion for one channel. Those skilled in the art will appreciate the manner in which conventional ABE may be performed. The output signal from the ABE component 403 is inputted to a high-pass filter component 405 configured to output a high band signal. The outputted high band signal is inputted into delay and energy adjustment components 407 and 409, one corresponding to each channel.

Delay and energy adjustment components 407 and 409 are configured to modify, separately for the respective right or left channel, the inputted high band signal. The modification to the high band signal is based upon the estimated delay and energy differences from ITD and ILD estimation component 403. The difference estimates are shown as inputs to the delay and energy adjustment components 407 and 409 by signal 415 shown in broken line form. Finally, via up-sampling components 411 and 413, the modified high bands are added to the original narrowband signals and a wideband binaural output signal with a doubled sampling rate, such as fs=16 kHz, is outputted. Aspects of the present invention may be implemented for additional channels and the description of two is merely illustrative. As such, aspects of the present invention may be implemented for multichannel speech signals in excess of two channels.

During simultaneous speech, speakers may be positioned to opposite sides of the listener. In such situation, a delayed speech signal of one speaker is in the left channel, whereas the other is in the right channel. The delay estimation is still calculated the same way as in a single speaker case, and for each frame, the delay of the dominant speaker is obtained and the frames are processed respectively.

Two illustrative examples for determining which one of the channels first serves as an input for the monophonic ABE algorithm component 403. In one embodiment, the same channel may be used all the time. In a second embodiment, the channel that has more energy at the moment may be used. This second embodiment has an advantage in that the ABE processed channel does not need further energy or phase adjustments, thus saving computational resources. For the other channel, the delay and the energy are modified to correspond to the original estimates. The energy difference may be used as an indicator since in a binaural signal, the polarity of the interaural time difference (ITD) is correlated with the corresponding interaural level difference (ILD) for a single sound source. As such, the signal in the contra-lateral, i.e., farther ear, channel is delayed and a low-pass filtered version of the corresponding signal is in the ipsi-lateral, i.e., nearer ear, channel. In accordance with another embodiment, it should be understood that interaural time difference (ITD) estimation also may be made for frequency bands of a signal. A signal may be split to various frequency bands and an ITD component may estimate between the corresponding bands. Then a combined ITD estimate may be made from these band-related estimates.

The high-pass filter component 405 used to extract the created high band for further modification is configured to have a cut-off frequency of 4 kHz. If the expansion starts from, for example, 3.4 kHz, where a traditional telephone band ends, the cut-off frequency would be lower respectively.

With respect to the ITD and ILD estimation component 401, one illustrative manner to estimate the delay between the channels of a binaural signal includes using an average magnitude difference function, such as,

$$d ( i ) = \frac{1}{N} {\sum }_{k = 1}^{N} \vert ( {x}_{l} ( k ) - {x}_{r} ( k - i ) ) \vert ,$$

where xₗ is the left channel, xᵣ is the right channel, N is the analysis frame length, and i is the delay. The average magnitude difference function, d(i), is an estimate of a time difference between two signals, xₗ and xᵣ. If the artificially created high band of one channel is copied to another signal, it has to be delayed/forwarded by the same amount as is the time difference between the original signals. Another illustrative manner is correlation based. A correlation based method may be, for example, cross correlation which is a generally known metric.

Another illustrative method is to include envelope matching metrics. Wong, Peter H. W. and Au, Oscar C.; “Fast SOLA-Based Time Scale Modification Using Envelope Matching”; Journal of VLSI Signal Processing Systems, Vol 35, Issue 1; August 2003, describes an example of where envelope matching is used for time scale modification.

In one embodiment, artificial bandwidth expansion (ABE) may be performed individually for both of the channels. However, in order to preserve the delay and level differences, some control between the expansions is needed. In one embodiment, such a control may be implemented through frame classification, because voiced speech frames, fricatives, and plosives are processed differently.

In another embodiment of the present invention, the incoming binaural signal may be analyzed to discriminate cases when there is only one speaker talking and when several simultaneous speakers are talking at the same time. Depending on the particular case, processing may be controlled differently. For example, when only one speaker is active, the processing may be performed according to one embodiment, and during simultaneous speech, bandwidth extension processing may be disabled or run individually for the channels.

One use of aspects of the present invention may be within a terminal device, such as terminal device 351. In a first embodiment, optional artificial room effect signal processing may be performed in a terminal device after the binaural artificial bandwidth expansion (B-ABE) processing. The room effect signal may takes on a monophonic input signal and may produce a binaural output. The monophonic downmix for the room effect may be made by mixing the input signal of different channels taken from the binaural input, before the ABE component 403 or after the ABE component 403. If the signal is taken after the ABE component, the downmix is a bandwidth expanded signal. The room effect may be processed in parallel the binaural input signal illustrated in FIG. 4. Outputs of the room effect may be added to the left and the right binaural output signal from FIG. 4.

The purpose of room effect processing in teleconferencing is to make the environment sound more natural and satisfactory to a listener. In addition, room effect improves externalization of sound sources in headphone listening. This means that a listener perceives sound sources to be located farther away than in her head, which is typical in headphone listening. With respect to this first embodiment, a conference bridge, such as conference bridge 301, is configured to produce a combined narrowband binaural signal. A conference bridge performs head related transfer function (HRTF) processing, binaural mixing, and narrowband (NB) encoding. A terminal device, operatively connected to the conference bridge is configured to perform NB decoding, binaural artificial bandwidth expansion (B-ABE) processing, room effect signal processing, and playback.

In a second embodiment, the artificial room effect may be generated and added to the binaural signal by a conference bridge. With respect to this second embodiment, a conference bridge, such as conference bridge 301, is configured to produce a combined narrowband binaural signal including an artificial room effect signal. A conference bridge performs head related transfer function (HRTF) processing, binaural mixing, room effect signal processing, and narrowband (NB) encoding. A terminal device, operatively connected to the conference bridge is configured to perform NB decoding, binaural artificial bandwidth expansion (B-ABE) processing, and playback.

In a third embodiment, one or more aspects of the present invention may be performed by a gateway configured to receive narrowband binaural signal and output a wideband binaural signal for a terminal device. With respect to this third embodiment, a gateway performs narrowband (NB) encoding, B-ABE processing, and wideband (WB) encoding. A terminal device, operatively connected to the gateway is configured to perform WB decoding and playback.

In a fourth embodiment, one or more aspects of the present invention may be implemented in a conference bridge capable of processing wideband signals. In accordance with aspects of the present invention, the conference bridge makes a wideband binaural signal from a narrowband binaural input signal before mixing the wideband binaural signal with several other binaural signals. Such a configuration would be beneficial if a narrowband binaural recording is received from certain participating sites. With respect to this fourth embodiment, a conference bridge, such as conference bridge 301, is configured to perform B-ABE processing on narrowband binaural inputs before making a wideband mix. A conference bridge performs B-ABE processing, binaural mixing, and wideband (WB) encoding. A terminal device, operatively connected to the conference bridge is configured to perform WB decoding and playback.

It should be understood by those skilled in the art that aspects of the present invention may be applied to telepresence applications, i.e., applications in which a participant is placed within a virtual environment, controlling devices to make the conference environment appear more realistic to the participant. In such a telepresence application, binaural recordings are used for teleconferencing and the remote session is recorded with a binaural microphone.

It should be further understood by those skilled in the art that the example of a high frequency bandwidth expansion described in FIG. 4 is but one example. Aspects of the present invention may be utilized with respect to a low frequency bandwidth expansion as well. As such, bandwidth expansion of a band limited speech signal includes low frequency bandwidth expansion or high frequency bandwidth expansion. With respect to the example of FIG. 4, high pass filter component 405 may be replaced by a band pass filter component. In such a configuration, ABE component 403 may be configured to process both low and high band signals.

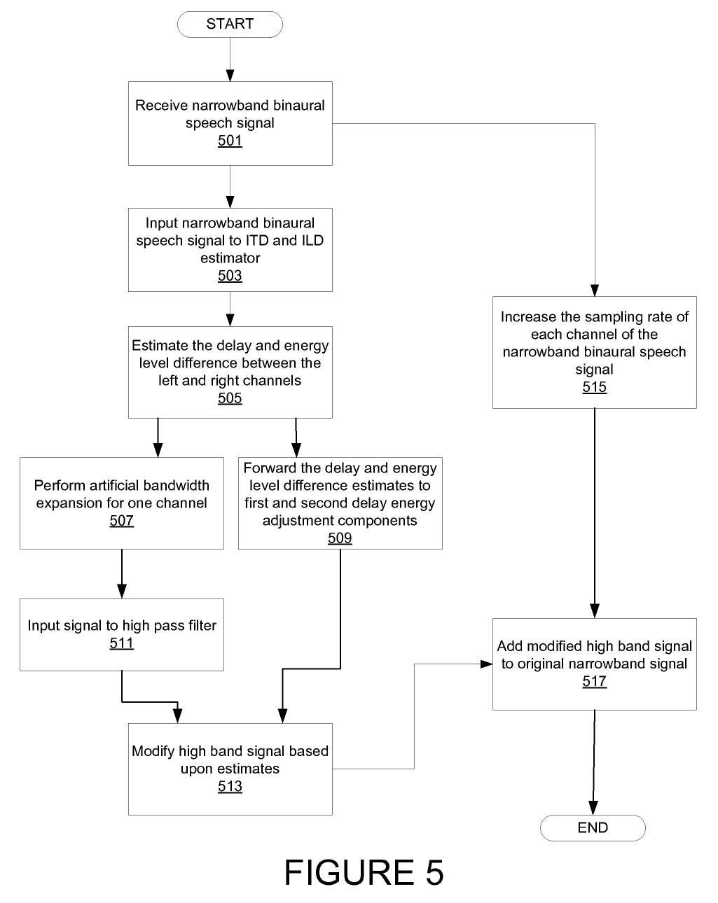

FIG. 5 is a flowchart of an illustrative example of a method for applying an artificial bandwidth expansion method for binaural speech signals (B-ABE) in a system in accordance with at least one aspect of the present invention. The process starts at step 501 where a narrowband binaural speech signal is received by the system. The narrowband binaural speech signal has a low sampling rate, such as fs=8 kHz. At step 503, the narrowband binaural speech signal is inputted to an interaural time difference (ITD) and interaural level difference (ILD) estimator, such as ITD and ILD estimation component 403 in FIG. 4.

Proceeding to step 505, the delay and energy level difference between the left and right channels of the narrowband binaural speech signal is estimated. As described herein, an average magnitude difference function may be utilized to perform this step 505. At step 507, for one of the left and right channels, an artificial bandwidth expansion algorithm expands the channel bandwidth. In one embodiment, the same channel may be used all the time, such as the left channel. In a second embodiment, the channel that has more energy at the moment may be used. It should be understood by those skilled in the art that in one embodiment, ABE processing may be calculated only for one channel where the created high band signal is added to both signals after adjusting the delay and energy levels separately for each. In another embodiment, ABE processing may be calculated for both channels separately.

From step 507, the process proceeds to step 511 where, the ABE processed signal is inputted to a high pass filter, such as high pass filter component 405, configured to output a high band signal. Again, it should be understood by those skilled in the art that a band pass filter may be used in place of a high pass filter in step 511. In such a case, a band limited signal may be processed as well.

From step 511, the process proceeds to step 513. Returning to step 505, a second output proceeds to step 509 where the delay and energy level difference estimates for each of the right and left channel are forwarded to first and second delay and energy level adjustment components, such as delay and energy adjustment components 407 and 409. The first delay and energy level adjustment component is configured to adjust one of the two channel signals and the second delay and energy level adjustment component is configured to adjust the other.

The delay and energy level difference estimate data from step 509 and the high band signal outputted from step 511 are inputted to step 513. At step 513, the high band signal is modified by the first and second delay and energy level adjustment components based upon the delay and energy level estimate data. From step 513, the process proceeds to step 517. Returning to step 501, the original narrowband binaural speech signal is up-sampled to increase the sampling rate of each of the two channels. The output from step 515 and the modified high band signal from step 513 proceed to step 517 where the two are added together. The output of step 517 is a wideband binaural speech signal with a doubled sampling rate, such as fs=16 kHz.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A system for applying artificial bandwidth expansion to a multichannel signal, the system comprising:
an estimation component configured to receive a multichannel signal and to estimate delay and energy level differences for each channel of the multichannel signal;
an artificial bandwidth expansion component, operatively connected to the estimation component, configured to artificially expand the bandwidth of at least one channel of the multichannel signal; and
a plurality of adjustment components, operatively connected to the artificial bandwidth expansion component, each of the plurality configured to modify a different one of the channels of the multichannel signal based upon the at least one artificial expanded channel and the estimated delay and energy level differences.

2. The system of claim 1, wherein the multichannel signal is a narrowband multichannel signal.

3. The system of claim 1, wherein the multichannel signal is band limited multichannel signal.

4. The system of claim 1, wherein the multichannel signal is a binaural speech signal.

5. The system of claim 1, wherein the multichannel signal is a speech signal of at least two sources.

6. The system of claim 1, further comprising a filter component, operatively connected to the artificial bandwidth expansion component, configured to output an artificial expanded band of the at least one channel of the multichannel signal.

7. The system of claim 6, wherein the filter component is a high pass filter component configured to output a high band signal for the artificial bandwidth expanded channel of the multichannel signal.

8. The system of claim 6, further comprising a plurality of up-sampling components, each configured to increase the sampling rate of a different channel of the multichannel signal, wherein for each channel, the up-sampled channel and the modified high band signal are added to output a wideband multichannel signal.

9. The system of claim 1, wherein the estimation component is further configured to estimate delay and energy level differences for each channel of the multichannel signal based upon an average magnitude difference function.

10. The system of claim 9, wherein the multichannel signal is a binaural speech signal and the average magnitude difference function is
$$d ( i ) = \frac{1}{N} {\sum }_{k = 1}^{N} \vert ( {x}_{l} ( k ) - {x}_{r} ( k - i ) ) \vert ,$$
where xₗ is a left channel of the binaural speech signal, xᵣ is the a right channel of the binaural speech signal, N is an analysis frame length, and i is a delay.

11. The system of claim 1, wherein a conference bridge includes the artificial bandwidth expansion component.

12. The system of claim 1, wherein a terminal device includes the artificial bandwidth expansion component.

13. The system of claim 1, wherein an artificial room effect signal is processed and added to the artificial bandwidth expanded channel.

14. The system of claim 1, wherein the artificial bandwidth expansion component is further configured to determine which channel of the multichannel signal to expand.

15. A method comprising:
estimating delay and energy level differences for each channel of a multichannel signal;
performing artificial bandwidth expansion of at least one channel of the multichannel signal; and
modifying a different one of the channels of the multichannel signal based upon the at least one artificial expanded channel and the estimated delay and energy level differences.

16. The method of claim 15, wherein the multichannel signal is a narrowband multichannel signal.

17. The method of claim 16, further comprising inputting the narrowband multichannel signal to an estimation component.

18. The method of claim 15, wherein the multichannel signal is a binaural speech signal.

19. The method of claim 15, further comprising inputting the at least one artificial bandwidth expanded channel into a high pass filter prior to the step of modifying.

20. The method of claim 15, further comprising increasing the sampling rate of the multichannel signal.

21. The method of claim 20, further comprising adding the increased sampling rate multichannel signal to the modified at least one artificial bandwidth expanded channel.

22. The method of claim 15, further comprising forwarding the estimated delay and energy level differences to a delay and energy level adjustment component.

23. The method of claim 15, wherein estimating delay and energy level differences is based upon an average magnitude difference function.

24. The method of claim 23, wherein the multichannel signal is a binaural speech signal and the average magnitude difference function is
$$d ( i ) = \frac{1}{N} {\sum }_{k = 1}^{N} \vert ( {x}_{l} ( k ) - {x}_{r} ( k - i ) ) \vert ,$$
where xₗ is a left channel of the binaural speech signal, xᵣ is the a right channel of the binaural speech signal, N is an analysis frame length, and i is a delay.

25. The method of claim 15, further comprising a step of determining whether to estimate data of the multichannel signal based upon metadata in the multichannel signal.

26. A system for applying artificial bandwidth expansion to a band limited multichannel signal, the system comprising:
means for estimating delay and energy level differences for each channel of a multichannel signal;
means for performing artificial bandwidth expansion of at least one channel of the multichannel signal; and
means for modifying a different one of the channels of the multichannel signal based upon the at least one artificial bandwidth expanded channel and the estimated delay and energy level differences.

27. The system of claim 26, wherein the means for estimating delay and energy level differences for each channel of the multichannel signal is based upon an average magnitude difference function.

28. A method comprising applying artificial bandwidth expansion to each cannel of a multichannel speech signal.

29. The method of claim 28, wherein the multichannel speech signal is a binaural speech signal.

30. An apparatus for applying artificial bandwidth expansion to a multichannel signal, the apparatus comprising:
an artificial bandwidth expansion component configured to artificially expand the bandwidth of each channel of a multichannel signal separately.

31. The apparatus of claim 30, wherein the apparatus is a terminal device.

32. The apparatus of claim 30, wherein the apparatus is a conference bridge component.
